(19) United States
(12) Patent Application Publication
(10) Pub. No.: US 2011/0067258 A1
(43) Pub. Date: Mar. 24, 2011

(54) Water-Removal Bucket

(75) Inventor: Yen-Fei HUANG, TAIPEI CITY (TW)

(73) Assignee: Yen-Fei HUANG, TAIPEI CITY (TW)

(21) Appl. No.: 12/628,202

(22) Filed: Nov. 30, 2009

(30) Foreign Application Priority Data
Sep. 18, 2009 (TW) 98217322

(51) Int. Cl. F26B 11/02; F16H 55/00

(52) U.S. Cl. 34/108; 74/640

(57) ABSTRACT

A water-removal bucket includes a frame, a pedal, a spur gear, a first bevel gear, a second bevel gear and a basket. The pedal is pivotally connected to the frame and meshes with the spur gear. The first bevel gear is connected to the spur gear via a linking shaft and meshes with the second bevel gear. The basket is connected to the second bevel gear via a driving shaft.

### RELATED APPLICATIONS

The application claims priority to Taiwan Application Serial Number 98217322, filed Sep. 18, 2009, which is herein incorporated by reference.

### BACKGROUND

1. Technical Field

The present disclosure relates to receptacles. More particularly, the present disclosure relates to water-removal buckets.

2. Description of Related Art

“Mop” is one of the common cleaning tools in the daily life. The mop usually cooperates with a bucket to clean the floor. For example, people usually wash the mop by the water-filling bucket and wring out the mop by their hand.

### SUMMARY

According to one embodiment of the present disclosure, the water-removal bucket includes a frame, a pedal, a spur gear, a first bevel gear, a linking shaft, a second bevel gear, a basket and a driving shaft. The pedal is pivotally connected to the frame and has a quadrant gear located thereon. The spur gear meshes with the quadrant gear of the pedal. The first bevel gear is pivotally connected to the frame. The linking shaft connects the spur gear and the first bevel gear. The second bevel gear is rotatably connected to the frame and meshes with a top portion of the first bevel gear. The driving shaft connects the second bevel gear and the basket.

### BRIEF DESCRIPTION OF THE DRAWINGS

FIG. 1 is a three dimensional view of a water-removal bucket according to one embodiment of the present disclosure;

FIG. 2 is an exploded view of the water-removal bucket of FIG. 1;

FIG. 3 is a three dimensional view of the pedal of FIG. 2;

FIG. 4 is a plan view of the spur gear and the first bevel gear of FIG. 1; and

FIG. 5 is an exploded view of the water-removal bucket of FIG. 1 and a container.

### DETAILED DESCRIPTION

In the following detailed description for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

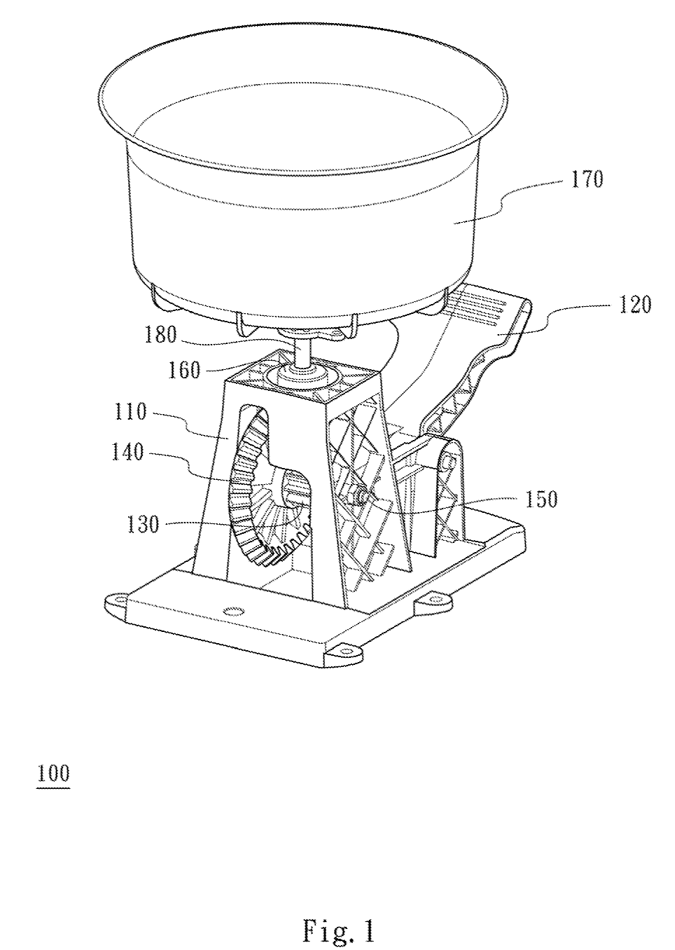

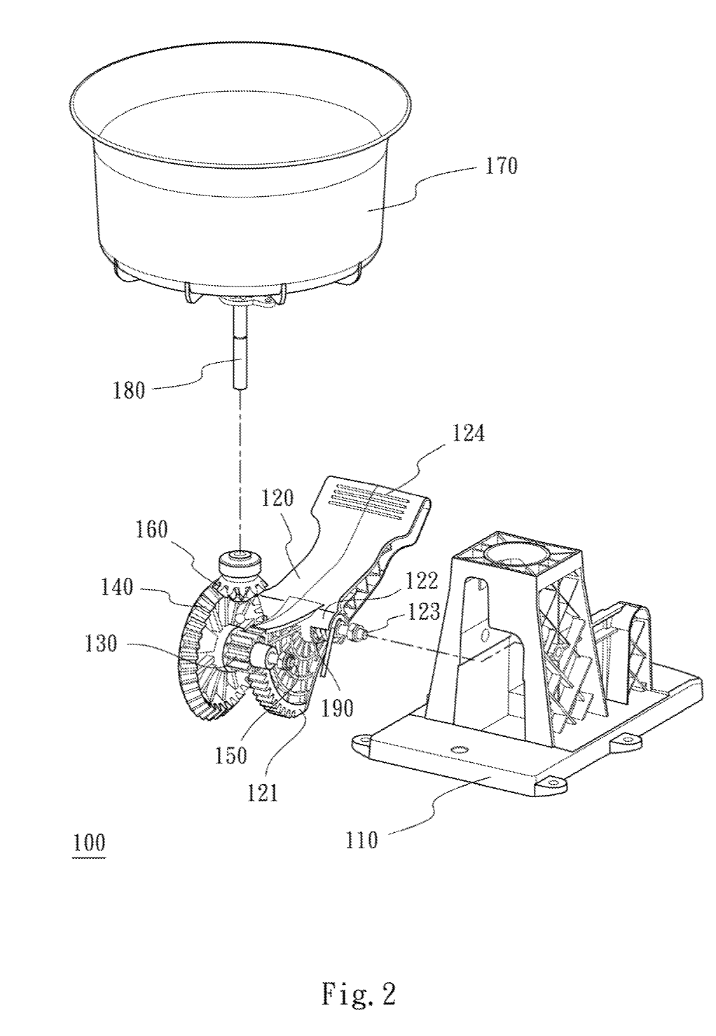

FIG. 1 is a three dimensional view of a water-removal bucket 100 according to one embodiment of the present disclosure. FIG. 2 is an exploded view of the water-removal bucket 100 of FIG. 1. The water-removal bucket 100 includes a frame 110, a pedal 120, a spur gear 130, a first bevel gear 140, a linking shaft 150, a second bevel gear 160, a basket 170 and a driving shaft 180. The pedal 120 is pivotally connected to the frame 110 and has a quadrant gear 121 located thereon. The spur gear 130 meshes with the quadrant gear 121 of the pedal 120. The first bevel gear 140 is pivotally connected to the frame 110. The linking shaft 150 connects the spur gear 130 and the first bevel gear 140. The second bevel gear 160 is rotatably connected to the frame 110 and meshes with a top portion of the first bevel gear 140. The driving shaft 180 connects the second bevel gear 160 and the basket 170.

When a user puts a rotatable mop into the basket 170 and pushes the to pedal 120 with his/her foot, the quadrant gear 121 of the pedal 120 can rotate the spur gear 130. The first bevel gear 140 and the second bevel gear 160 can translate the rotation of the spur gear 130 into the rotation of the basket 170. Therefore, the water of the rotatable mop can be removed.

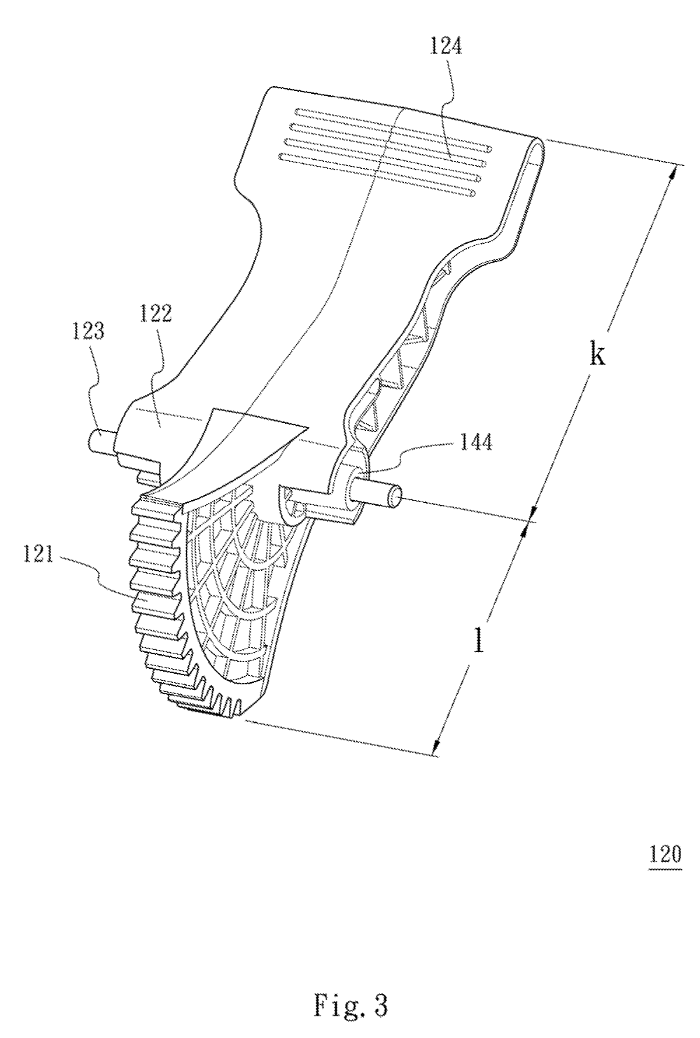

FIG. 3 is a three dimensional view of the pedal 120 of FIG. 2. The pedal is 120 includes an arm 122, a pivot 123 and a pedal plate 124. The pivot 123 pivotally connects the arm 122 to the frame 110. The pedal plate 124 and the quadrant gear 121 are connected to opposite ends of the arm 122. There are a first distance l between the quadrant gear 121 and the pivot 123 and a second distance k between the pivot 123 and the pedal plate 124. The first distance l is shorter than the second distance k. Therefore, the user can push the pedal 120 in a labor-saving way.

Reference is made to FIG. 2. The water-removal bucket 100 further includes a torsion spring 190. The torsion spring 190 surrounds the pivot 123 of the pedal 120, wherein one end of the torsion spring 190 is against the frame 110, and the other end of the torsion spring 190 is against the arm 122 of the pedal 120. Therefore, the pedal 120 is restorable by the torsion spring 190.

The length direction of the pivot 123 of the pedal 120 is orthogonal to the length direction of the driving shaft 180. This orthogonal relationship can increase the stability of the water-removal bucket 100 and thus decrease the noise of the water-removal bucket 100, especially when the user pedals the pedal 120.

In addition, the spur gear 130, the first bevel gear 140 and second bevel gear 160 are contained by the frame 110. Therefore, the volume of the water-removal bucket 100 is decreased.

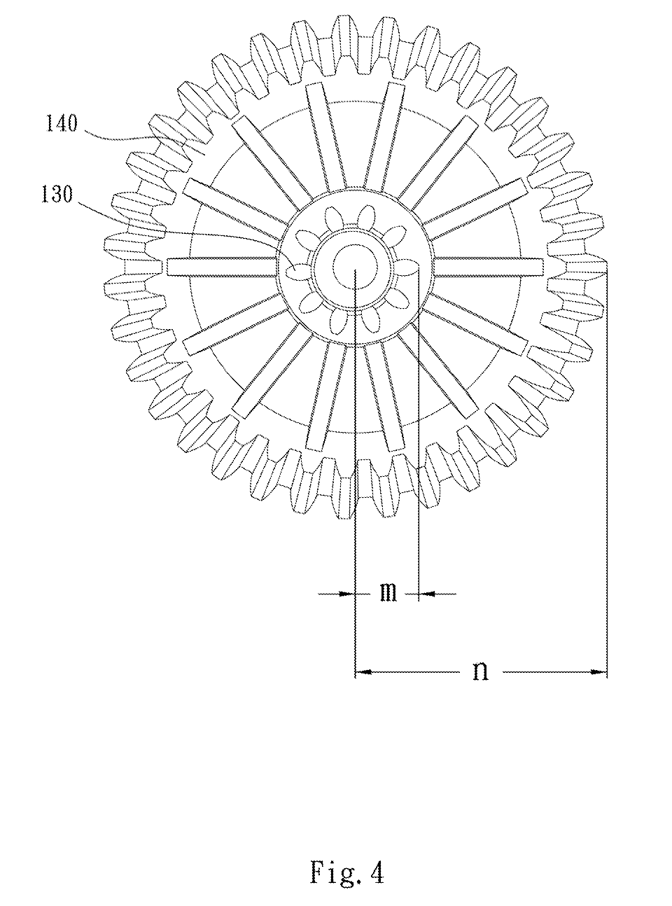

FIG. 4 is a plan view of the spur gear 130 and the first bevel gear 140 of FIG. 1. The radius m of the spur gear 130 is shorter than the radius n of the first bevel gear 140. It is easier to drive the spur gear 130 than to drive the first bevel gear 140. Therefore, the efficiency of the water-removal bucket 100 is increased.

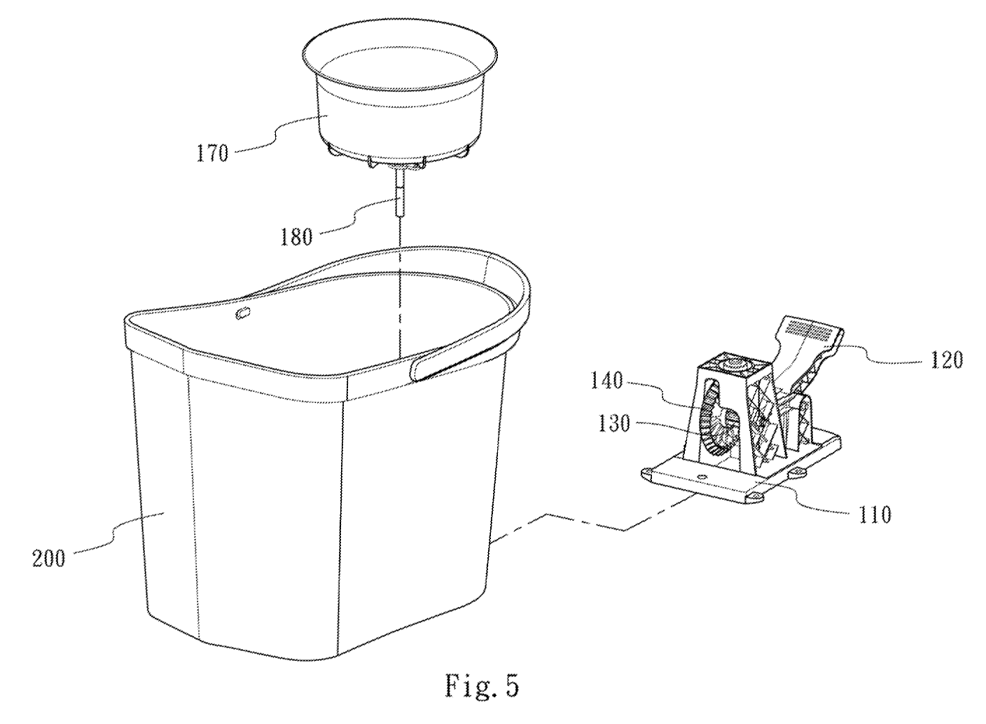

FIG. 5 is an exploded view of the water-removal bucket 100 of FIG. 1 and a container 200. The user can fill water into the container 200 and wash the rotatable mop in the container 200. Then, the user can remove the water of the mop by pedaling the pedal 120 of the water-removal bucket 100.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A water-removal bucket, comprising:
a frame;
a pedal pivotally connected to the frame and having a quadrant gear located thereon;
a spur gear meshing with the quadrant gear of the pedal;
a first bevel gear pivotally connected to the frame;
a linking shaft connecting the spur gear and the first bevel gear;
a second bevel gear rotatably connected to the frame and meshing with a top portion of the first bevel gear;
a basket; and
a driving shaft connecting the second bevel gear and the basket.

2. The water-removal bucket of claim 1, wherein the radius of the spur gear is shorter than the radius of the first bevel gear.

3. The water-removal bucket of claim 1, wherein the pedal comprises:
an arm;
a pivot pivotally connecting the arm to the frame; and
a pedal plate, the pedal plate and the quadrant gear connected to opposite ends of the arm, wherein a first distance between the quadrant gear and the pivot is shorter than a second distance between the pivot and the pedal plate.

4. The water-removal bucket of claim 3, further comprising:
a torsion spring surrounding the pivot of the pedal, wherein one end of the torsion spring is against the frame, and the other end of the torsion spring is against the arm of the pedal.

5. The water-removal bucket of claim 3, wherein the length direction of the pivot of the pedal is orthogonal to the length direction of the driving shaft.
